(19) United States
(12) Patent Application Publication
(10) Pub. No.: US 2008/0178225 A1
(43) Pub. Date: Jul. 24, 2008

(54) Method and system for storing and accessing video data

(75) Inventor: Larry Jost, St. Louis, MO (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/656,881

(22) Filed: Jan. 23, 2007

(51) Int. Cl. G06F 3/00

(52) U.S. Cl. 725/58

(57) ABSTRACT

Methods and systems for storing and accessing video data are presented. A method of storing video data may include receiving a reservation request to reserve a program for a user. The method may also include determining whether a reservation window associated with the program has expired. The reservation window may be based at least partially on a previously received reservation request. The method may also include storing a reservation record associating the program with the user after determining that the reservation window has not expired.

### FIELD OF THE DISCLOSURE

The present disclosure is generally related to storing and accessing video data.

### BACKGROUND

Digital video recorders (DVRs) may allow users to record programs onto a memory medium to be accessed at a later time. DVRs may also allow users to control the display of the programs, for example, by allowing a user to pause “live” television.

Typically, to implement these features a DVR may be deployed at each individual residence. Providing a DVR to each subscriber's residence may be expensive. Additionally, installation and maintenance of residentially deployed DVRs may add considerable expense. Such DVRs may have limited storage capacity that is relatively inconvenient to expand. DVRs may not allow a user to access a program that was broadcast in the past. Additionally, DVRs may not allow a user to record substantially all available channels simultaneously.

Systems have been proposed to utilize network DVRs, which may record and store data at a network server of a video service provider. Storing video for access by subscribers at a network DVR may require that a considerable amount of data be stored. Hence there is a need for an improved method and system for storing and accessing video data.

### BRIEF DESCRIPTION OF THE DRAWINGS

FIG. 1 depicts a first embodiment of a system for storing and accessing video data;

FIG. 2 depicts a second embodiment of a system for storing and accessing video data;

FIG. 3 depicts a flow chart of a first embodiment of a method of storing video data;

FIG. 4 depicts a flow chart of a second embodiment of a method of storing video data;

FIG. 5 depicts a flow chart of a third embodiment of a method of storing video data;

FIG. 6 depicts a flow chart of an embodiment of a method of accessing stored video data;

FIG. 7 depicts a block diagram of a system for storing and accessing video data; and

FIG. 8 depicts a block diagram of a general computer system.

### DETAILED DESCRIPTION OF THE DRAWINGS

In a particular embodiment, a system for storing and accessing video data may include a memory to store a plurality of program data files associated with recorded programs. The system may also include a retention module to determine whether to retain each of the plurality of program data files based at least partially on a variable retention window. The variable retention window may be varied based at least partially on user interaction with the recorded programs.

In a particular embodiment, a method of storing video data may include receiving a reservation request to reserve a program for a user. The method may include determining whether a reservation window associated with the program has expired. The reservation window may be based at least partially on a previously received reservation request. The method may also include storing a reservation record associating the program with the user after determining that the reservation window has not expired.

In a particular embodiment, a method of storing video data may include determining whether a variable retention window associated with a program has expired. The method may also include deleting the program after determining that the variable retention window has expired.

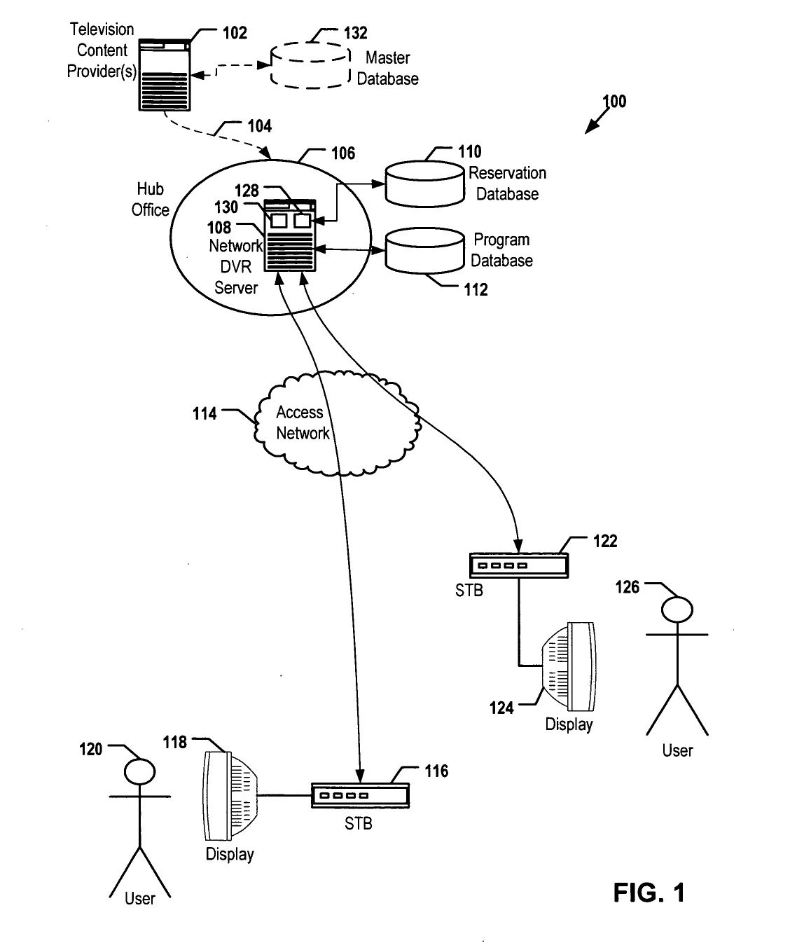

FIG. 1 depicts a first particular embodiment of a system for storing and accessing video data. The system 100 includes a content provider, such as a television content provider 102. The system 100 also includes a video data distribution access network including a hub office 106 and an access network 114. The access network 114 is connected to user devices, such as set-top boxes 116 and 122.

In a particular embodiment, the video data distribution access network may distribute video content data received from the television content provider 102 via the access network 114 to set-top boxes 116 and 122 for display on displays 118 and 124 to users 120 and 126, respectively. It is understood that the video data distribution access network may serve any number of subscribers, and may include any number of set-top boxes.

In a particular illustrative embodiment, the hub office 106 may include a network digital video recorder (DVR) server 108. The network DVR server 108 may be in communication with a program database 112. The program database 112 may store video data. For example, the video data may include recorded video programming received from the television content provider 102 via a communication channel 104 and stored in one or more program data files. In a particular illustrative embodiment, the network DVR server 108 may include a retention module 130. The retention module 130 may determine whether to retain each program data file in the program database. For example, the retention module 130 may determine a retention window associated with each program data file. The retention window may set a time period after which the associated program data file may be deleted from the program database. In a particular embodiment, the retention window may include a variable retention window that is varied based at least partially on user interaction with the recorded programs.

In a particular embodiment, the network DVR server 108 may also be in communication with a reservation database 110. The reservation database 110 may include a plurality of records which associate individual users, such as user 120 or user 126, with video data stored in the program database 112. In a particular illustrative embodiment, the program database 112 may store one copy of each program file. In such an embodiment additional users may be associated with the program file through the addition of records in the reservation database 110.

In a particular embodiment, the network DVR server 108 may include a reservation module 128. The reservation module 128 may store reservation records in the reservation database 110. Additionally, the reservation module 128 may determine a reservation window associated with each recorded program. The reservation window may establish a time limit after which the recorded program may no longer be reserved by a user. In a particular embodiment, the reservation window may include a variable reservation window and or a fixed reservation window.

In a particular embodiment, either the program database 112 or the reservation database 110 may be associated with, retained by or controlled by the television content provider 102. For example, in a particular illustrative embodiment, the television content provider 102 may include a master database 132. In an illustrative embodiment, the master database 132 may be used to control retention of programs in the one or more distributed program databases 112. In another illustrative embodiment, the master database 132 may be used to control reservation of programs in the one or more distributed reservation databases 110. The master reservation database 132 may also be used to gather statistical information regarding reservation and/or retention of programs at multiple distributed hub offices 106.

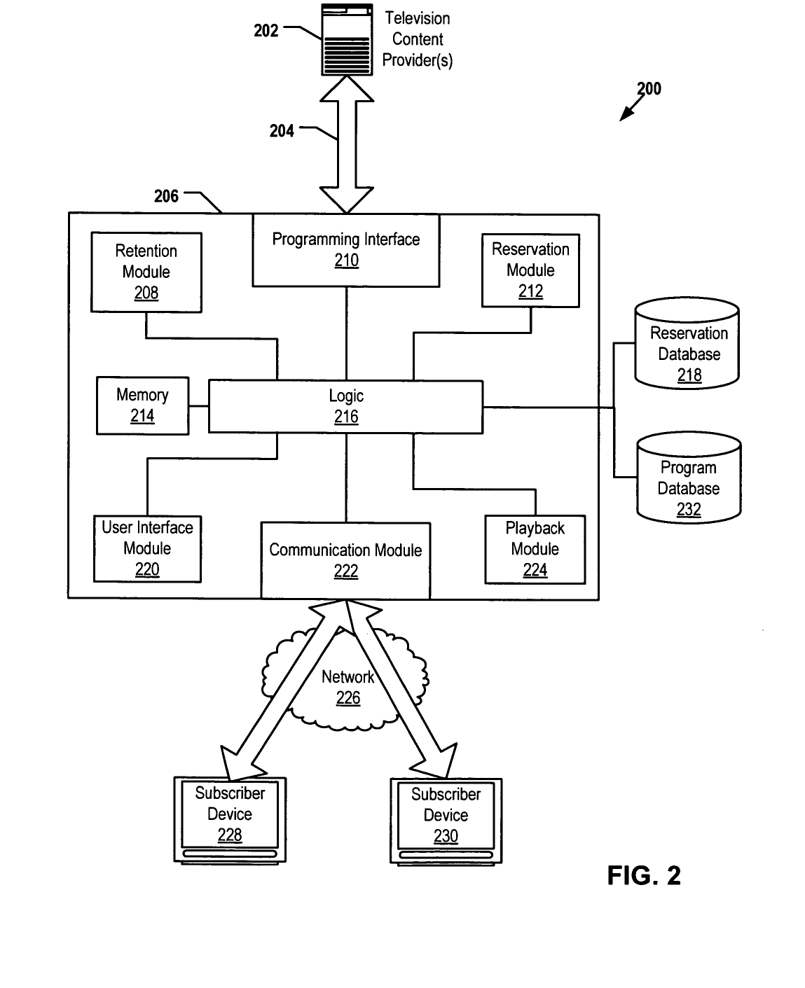

FIG. 2 depicts a second particular embodiment of a system for storing and accessing video data. The system 200 includes a television content provider 202 communicating via a communication channel 204 with a network DVR server 206. The network DVR server 206 is in communication with a plurality of subscriber devices 228 and 230 through an access network 226.

The network DVR server 206 includes a retention module 208, a programming interface 210, a reservation module 212, a memory 214, logic 216, a user interface module 220, a communication module 222, and a playback module 224. In an illustrative embodiment, the modules may be implemented in hardware, software, or any combination thereof. The network DVR server 206 also includes or is in communication with a reservation database 218 and a program database 232.

In a particular embodiment, the programming interface 210 receives television programming from the television content provider 202 via the communication channel 204 and records the programming to the program database 232 as one or more program data files. The communication channel 204 may include satellite signals, fiber-optic signals, air-wave broadcast signals, other radio frequency signals, or any combination thereof. The particular format of the television programming or the protocol used to send the television programming may vary in different embodiments.

In a particular embodiment, the communication module 222 may receive user control commands via the network 226. For example, the control commands may include a control command requesting reservation of a particular program in the program database 232. In another example, the control commands may include a playback request requesting that a program in the program database 232 be transmitted to a user device 228 or 230 associated with the requesting user. In another example, the control commands may include a request to delete a program reservation from the reservation database 218. In a particular embodiment, the control commands may be received by the communications module 222 via a user interface displayed at the subscriber device 228 or 230. The user interface may be generated by the user interface module 220 and sent to the subscriber device 228 or 230 via the network 226. In another illustrative embodiment, the user interface may be generated by a user interface module at the subscriber device 228 or 230.

In a particular embodiment, the reservation module 212 may determine a reservation window associated with a program in the program database 232. The reservation window may establish a time period during which the program is available to be reserved by a user. Reserving a program associates the program with the user, allowing the user to request playback of the program. That is, a reservation record associating a program with a user informs the network DVR system 206 that the user desires to retain the program in the program database 232 for possible later viewing. In response to receiving a request to reserve a program, the logic module 216 may invoke the reservation module 212. If the reservation module 212 determines that the reservation window associated with the program has not expired, the reservation module 212 may generate a reservation record to associate the requesting user with the program.

In a particular embodiment, the reservation window may include a fixed reservation window and/or a variable reservation window. The fixed reservation window may establish a maximum time limit during which the program may be reserved. In an illustrative embodiment, the fixed reservation window may be determined based on the type of program. For example, an entertainment program, such as a movie or television series, may have a relatively long fixed reservation window since its may remain relevant to users as entertainment for a relatively long period of time (e.g., months or even years). In contrast, a current event related program, such as a news program or sporting event, may have a relatively short fixed reservation window since its value to users may decrease substantially over a relatively short period of time (e.g., hours or days). In another illustrative embodiment, the variable reservation window may be based on the popularity of the program. The popularity of the program may be based on data such as estimates of the audience size for the program (e.g., Nielsen ratings of the program), the rate at which reservation requests are received, the number of reservation requests received, other measures of popularity of a program, or any combination thereof. In a particular illustrative embodiment, a more popular program may generally have a longer variable reservation window.

In a particular embodiment, the reservation module 212 may also determine whether a user reservation limit associated with the requesting user has been met. If the user has met or exceeded a reservation limit associated with the user, the user may not be allowed to reserve additional programs.

In a particular embodiment, the reservation module 212 may periodically or occasionally determine whether to modify one or more reservation records. For example, each reservation record may include a reservation time limit. The reservation time limit may specify how long the program is to be associated with the user. When the reservation module 212 determines that the reservation time limit of a reservation record has expired, the reservation record may be modified so that the program is no long associated with the user. In another example, a reservation record may be modified by the reservation module 212 in response to receiving a request from a user to delete a reservation.

In a particular embodiment, the retention module 208 may determine a retention window associated with a particular program in the program database 232. The retention window may establish a time period after which the program may be deleted from the program database 232. The retention module 208 may also determine when the retention window for the program has expired, and may delete the program from the program database 232 after the retention window has expired. As used herein, a program or data file may be considered “deleted” when a memory location associated with the program or data file is marked for over-writing, even if the program or data file is not actually removed or over-written from the memory location at that time.

In a particular embodiment, the retention window may include a fixed retention window and a variable retention window. The fixed retention window may establish a maximum time limit for storing the program. In an illustrative embodiment, the fixed retention window may be determined based on the type of program. For example, an entertainment program, such as a movie or television series, may have a relatively long fixed retention window since its may remain relevant to users as entertainment for a relatively long period of time (e.g., months or even years). In contrast, a current event related program, such as a news program or sporting event, may have a relatively short fixed retention window since its value to users may decrease substantially over a relatively short period of time (e.g., hours or days).

A variable retention window may reduce the length of time that the program is retained based on user interaction with the program. The variable retention window, for example, may be shorter than the fixed retention window. In an illustrative embodiment, the duration of the variable retention window may be fixed, and the start time of the variable retention window may be modified based on certain user actions. That is, the variable retention window may be a sliding window. For example, the variable retention window may begin anew each time a user requests playback of the program or each time a user reserves the program. In another example, the variable retention window may begin after the rate of new reservation requests drops below a pre-determined threshold or after the reservation window for the program has expired. In an illustrative embodiment, the variable retention window may have a variable duration. For example, the duration of the variable retention window may be adjusted based on how many requests to view the program are received.

In a particular embodiment, the retention module 208 may delete a program after the retention window(s) associated with the program have expired. In another illustrative embodiment, the retention module 208 may delete a program after determining that fewer than a threshold number of reservation requests are associated with the program. For example, even if the reservation window for the program has expired and there are fewer than the threshold number of reservation requests associated with the program, the retention module 208 may delete the program.

In a particular embodiment, the logic module 216 may invoke the playback module 224 after receiving a request to playback a recorded program from a user via the subscriber device 228 or 230. The user may send a control command requesting playback of a recorded program via a user interface presented via subscriber device 228 or 230. The user interface may be generated by the user interface module 220, or by a user interface module at the subscriber device 228 or 230. The user interface may be generated based on reservation records stored in the reservation database 218. For example, the user interface may include a menu of recorded programs associated with the subscriber based on reservation records stored in the reservation database 218.

In a particular embodiment, the playback module 224 may access the recorded program and send the recorded program data via the network 226 to the subscriber device 228 or 230. In a particular embodiment, the playback module 224 may stream the program data to the subscriber device 228 or 230. During streaming of the program data the user may issue a control command via the subscriber device 228 or 230 to the network DVR server 206. For example, the control command may be a pause command, stop command, re-wind command, fast forward command, or another control command. The logic 216 may implement the control command by changing the data streamed to the subscriber device 228 or 230. In a particular embodiment, the logic 216 may inhibit certain control commands, such as a fast forward command that is received during playback of an advertisement. In so doing, the logic 216 may inhibit the subscriber from avoiding at least one advertisement.

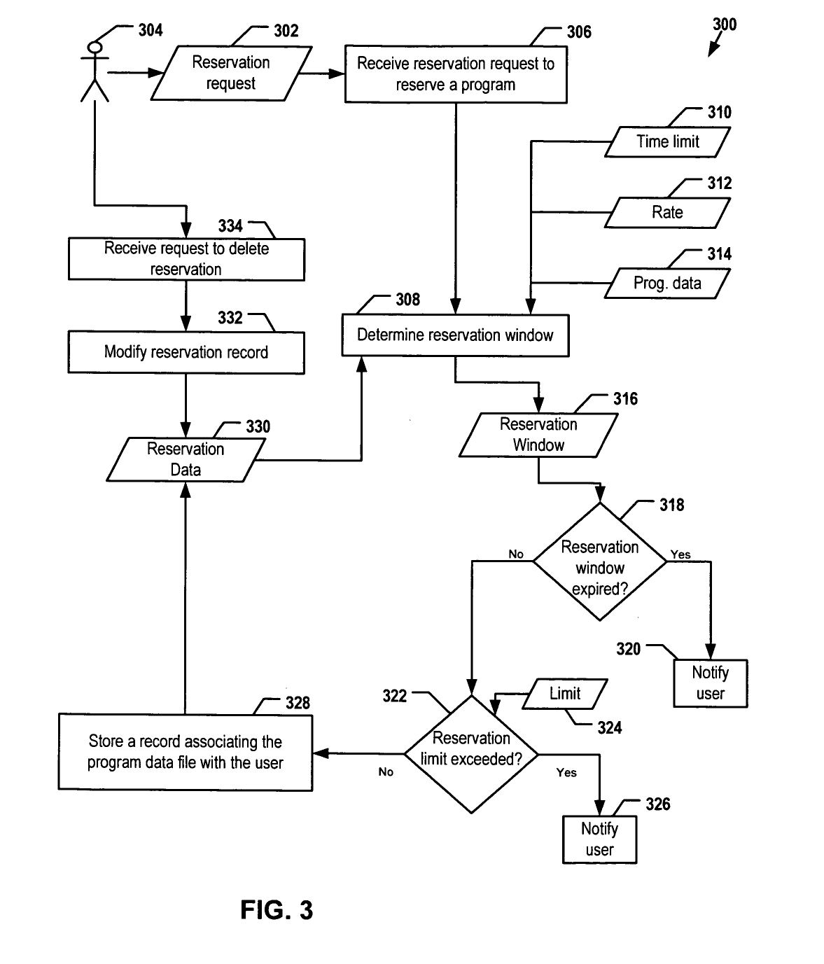

FIG. 3 depicts a flow chart of a first particular embodiment of a method of storing video data. The method 300 includes, at 306, receiving a reservation request 302 to reserve a program from user 304. The method 300 also includes, at 308, determining a reservation window associated with the program. The reservation window may be determine based on a fixed time limit 310. The reservation window may also be determined based on statistical information pertaining to the program or popularity of the program, such as, the rate 312 at which reservation requests for the program have been received, the number of reservation requests received, when the last reservation request was received, and so forth. The reservation window may also be determined based on program data 314, such as the type of program or historical popularity of the program.

After determining the reservation window 316, the method 300 may include determining whether the reservation window 316 has expired, at 318. If the reservation window 316 has expired, the user may be notified, at 320. In a particular embodiment, determining the reservation window and whether the reservation window has expired may be performed before receiving a reservation request from the user. For example, the method 300 may determine whether a program is available to be reserved before presenting a user interface display to a user listing programs available for reservation.

In a particular illustrative embodiment, if the reservation window 316 has not expired, the method may include, at 322, determining whether a user reservation limit 324 associated with the user would be exceeded. If the user reservation limit 324 would be exceeded, the user may be notified at 326. If the user reservation limit 324 would not be exceeded, the method 300 may include, at 328, storing a record associating the user with the program or one or more program data files that make up the program.

In a particular illustrative embodiment, the reservation limit 324 may be based on a total size of the plurality of program data files associated with the user 304. For example, the user 304 may be allocated a particular reservation limit on the network DVR server. In a particular embodiment, the reservation limit 324 may establish a total amount of memory that may be used to store programs reserved by the user 304. In a particular illustrative embodiment, the reservation limit 324 may establish a total number of active reservations that may be associated with the user 304. For example, the user 304 may be allocated a particular number of active reservations. In a particular illustrative embodiment, the reservation limit 324 may establish a total number of hours for reserved programs that may be associated with the user 304. For example, the user 304 may be allocated a particular number of program hours that may not be exceeded by the total amount of time required to view all of the programs reserved by the user. In another particular illustrative embodiment, the reservation limit 324 may establish a limit on the number of reservation hours that may be associated with the user 304. Reservation hours refers to the sum of the total number of hours required to view each program times how many hours each program is requested to be reserved. For example, if a first program is one (1) hour long, and it is reserved for two days (48 hours), the reservation hours associated with the first program are 1×48, or 48 reservation hours. Similarly, if a second program is two (2) hours long, and it is reserved for one week (168 hours), the reservation hours associated with the second program are 2×168, or 336 reservation hours. The sum of the reservation hours associated with the first and second programs is therefore 384 reservation hours. In a particular illustrative embodiment, the reservation limit 324 may include more than one type of limit. For example, the user 304 may be allocated limits for different types of storage, such as, short-term storage, long-term storage and indefinite storage. A program marked for short-term storage may be associated with the user 304 for a relatively short time period, such as one or more days. A program marked for long-term storage may be associated with the user 304 for a relatively long time period, such as one or more weeks or months. A program marked for indefinite storage may be associated with the user 304 until the user 304 requests that the reservation be deleted. The reservation limit 324 may include different amounts of short-term storage, long-term storage, indefinite storage, or any combination thereof.

The method 300 also includes, at 334, receiving a request to delete a reservation. In response to the request to delete the reservation, the method 300 may modify the reservation record 330 so that the user 304 is no longer associated with the program, at 332.

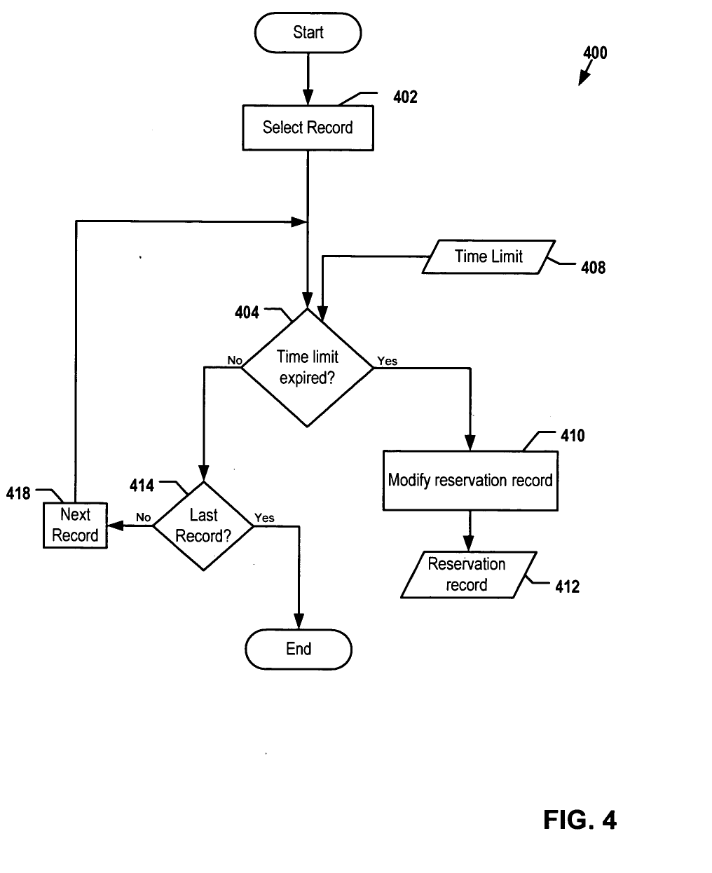

FIG. 4 depicts a flow chart of a second particular embodiment of a method of storing video data. The method 400 includes housekeeping functions that may be implemented periodically or occasionally by the reservation module 212 depicted in FIG. 2. The method 400 includes, at 402, selecting a reservation record to review. The method 400 also includes, at 404, determining whether a time limit 408 associated with the record has expired. In an illustrative embodiment, the time limit 408 may include a user specified time limit indicating how long the user wishes to reserve a particular program. In an illustrative embodiment, the time limit 408 includes a time limit imposed by the network DVR provider indicating a maximum amount of time that a user may reserve a program.

If the time limit 408 has expired, the method 400 may include, at 410, modifying the reservation record 412 so that the user is no longer associated with the program. If the time limit 408 has not expired, the method 400 may include, at 414, determining whether another record is to be examined. If there are no more records to examine, the method 400 ends. If there are more records to examine, the method 400 may advance to the next record, at 418, and iterate.

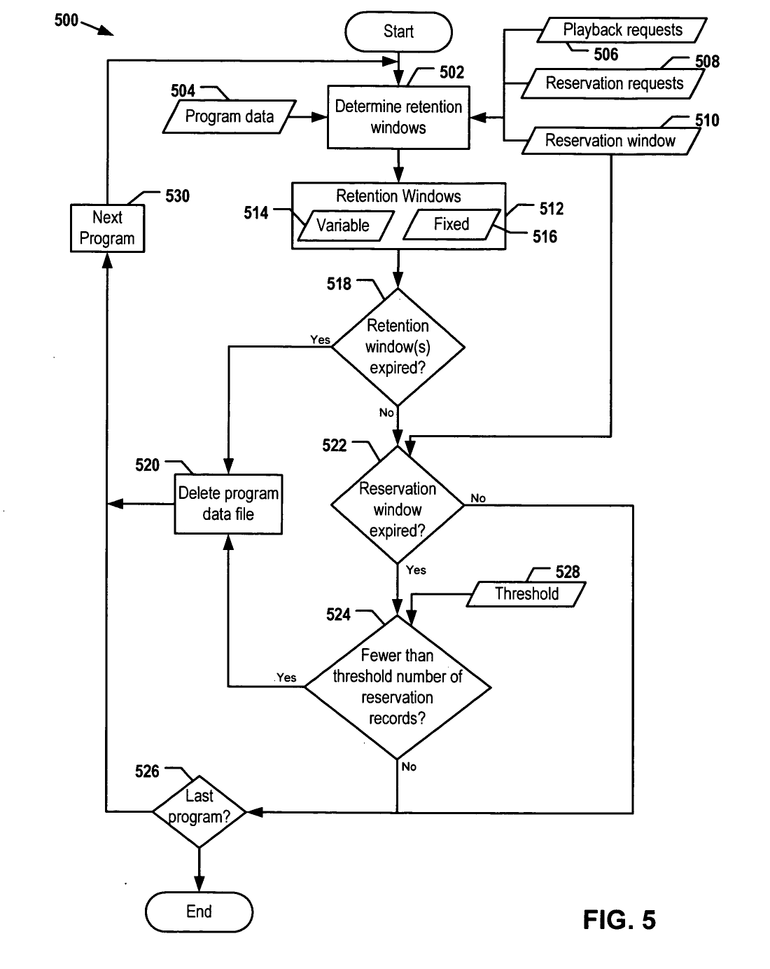

FIG. 5 depicts a flow chart of a third particular embodiment of a method of storing video data. The method 500 includes housekeeping functions that may be implemented periodically or occasionally by the retention module 208 depicted in FIG. 2. The method 500 includes, at 502, determining one or more retention windows 512 associated with a recorded program. The retention windows 512 may, for example, include a fixed retention window 514 and/or a variable retention window 516. The retention windows 512 may establish time periods after which the program may be deleted from the program database.

In a particular embodiment, the fixed retention window 516 may establish a maximum time limit for storing the program. The fixed retention window 516 may be determined based on program data 504, such as the type of program. For example, an entertainment program, such as a movie or television series, may have a relatively long fixed retention window since its may be relevant to users as entertainment for a relatively long period of time (e.g., months or even years). In contrast, a current event related program, such as a news program or sporting event, may have a relatively short fixed retention window since its value to users may decrease substantially over a relatively short period of time (e.g., hours or days).

In a particular embodiment, the variable retention window 514 may be shorter than the fixed retention window 516. The variable retention window 514 may be moved or reset based on user interactions with the program. In an illustrative embodiment, the variable retention window 514 may be of a fixed duration that is shifted in time to vary the expiration of the variable retention window 514. In another illustrative embodiment, the total duration of the variable retention window may be increased or decreased to vary the expiration of the variable retention window 514.

In a particular embodiment, the variable retention window 514 may be modified based on user playback requests 506. For example, each time a user requests playback of the program the variable retention window 514 may start over. In another illustrative embodiment, the variable retention window 514 may be modified based on reservation requests 508. For example, each time a user reserves the program, the variable retention window 514 may be reset. In another example, the number or rate at which reservation requests 508 are received may be used to determine the beginning point or the duration of the variable retention window 514. Thus, for example, a more popular program may be given a longer variable retention window 514. In another illustrative embodiment, the variable retention window 514 may be modified based on the reservation window 510 associated with the program. For example, the variable retention window 514 may be modified when the reservation window 510 is modified so that the variable retention window 514 is at least as long as the reservation window 510. In an illustrative embodiment, the time period of the variable retention window 514 may be started after the rate of new reservation requests 508 drops below a pre-determined threshold or after the reservation window 510 for the program has expired. In another illustrative embodiment, the variable retention window 514 may be modified based on other user interactions with the recorded program, or any combination of the above.

The method 500 also includes, at 518, determining whether the retention windows 512 have expired. In a particular embodiment, the method 500 may determine, at 518, whether the earliest of the retention windows 512 has expired. For example, if the fixed retention window 516 expires before the variable retention window 514, only the fixed retention window 516 may be considered. Likewise, if the variable retention window 514 expires before the fixed retention window 516, only the variable retention window 514 may be considered.

If a retention window 512 has expired, the method 500 may include, at 520, deleting the program data file or program data files associated with the program. If no retention window has expired, the method 500 may include, at 522, determining whether the reservation window 510 associated with the program has expired. If the reservation window 510 has not expired, the method 500 may include, at 526, determining whether another program is to be considered. If additional programs are to be considered, the method 500 may advance to the next program, at 530.

If the reservation window 510 has expired, the method 500 may include, at 524, determining whether fewer than a threshold number 528 of reservation records are associated with the program. If fewer than the threshold number 528 of reservation records are associated with the program, the method may include, at 520, deleting the program data file. If the number of reservation records associated with the program is equal to or greater than the threshold number 528 of reservation records, the method 500 may include, at 526, determining whether another program file is to be considered. The threshold number 528 of reservation records may be established by the provider of the network DVR service. For example, the threshold number 528 of reservation records may be one. That is, as long as one user has reserved the program, the program may not be deleted. However, in other embodiments, the threshold number 528 of reservation records may be set higher than one to strike a balance between business goals such as, satisfying users of the system, and overcoming the economic or technological barriers to storing large amounts of program data.

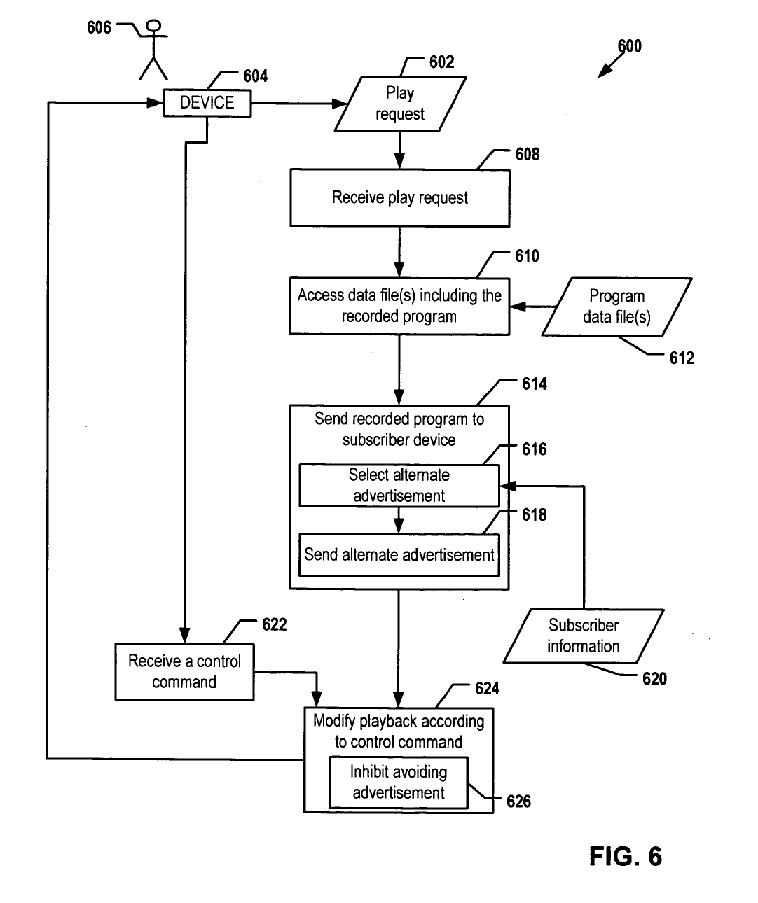

FIG. 6 depicts a flow chart of a particular embodiment of a method accessing stored video data. The method 600 includes, at 608, receiving a play request 602 from a subscriber 606 via a subscriber device 604. The play request 602 indicates a recorded program to be sent to the subscriber device 604. The method 600 also includes, at 610, accessing a program data file 612 that includes the recorded program. The method 600 also includes, at 614, sending the recorded program to the first subscriber device 604.

In an illustrative embodiment, the method 600 may include, at 616 selecting an alternate advertisement based on subscriber information 620. The subscriber information 620 may include information related to preferences, purchasing habits, programs, other information relevant to marketing products or services to the subscriber, or any combination thereof.

In a particular embodiment, the method 600 may include sending at least one alternate advertisement with the recorded program, at 618. The at least one alternate advertisement may include an advertisement that was not included in the recorded program when the recorded program was recorded.

In a particular illustrative embodiment, the method 600 may include, at 622, receiving a control command from the user 606 via the device 604. The method 600 may also include, at 624, modifying playback of the recorded program according to the control command. In a particular embodiment, the method 600 may also include, at 626, inhibiting the user 606 from avoiding advertisements. For example, the user 606 may be inhibited from fast forwarding or advancing playback of a program during an advertisement.

In a particular illustrative embodiment, inhibiting the user 606 from avoiding advertisements and/or including alternate advertisements during playback of the recorded program may be facilitated by storing advertisement markers in the program data file 612. Each advertisement marker may indicate the beginning of an advertisement or block of advertisements, or the end of an advertisement or block of advertisement. The advertisement markers may be based on, for example, information derived from the program itself, information received from a television content provider, or any combination thereof. In a particular illustrative embodiment, a network DVR server, such as network DVR server 206 illustrated in FIG. 2, may monitor the beginning and ending of a block of advertisements, and may block execution of user commands that would avoid the advertisements.

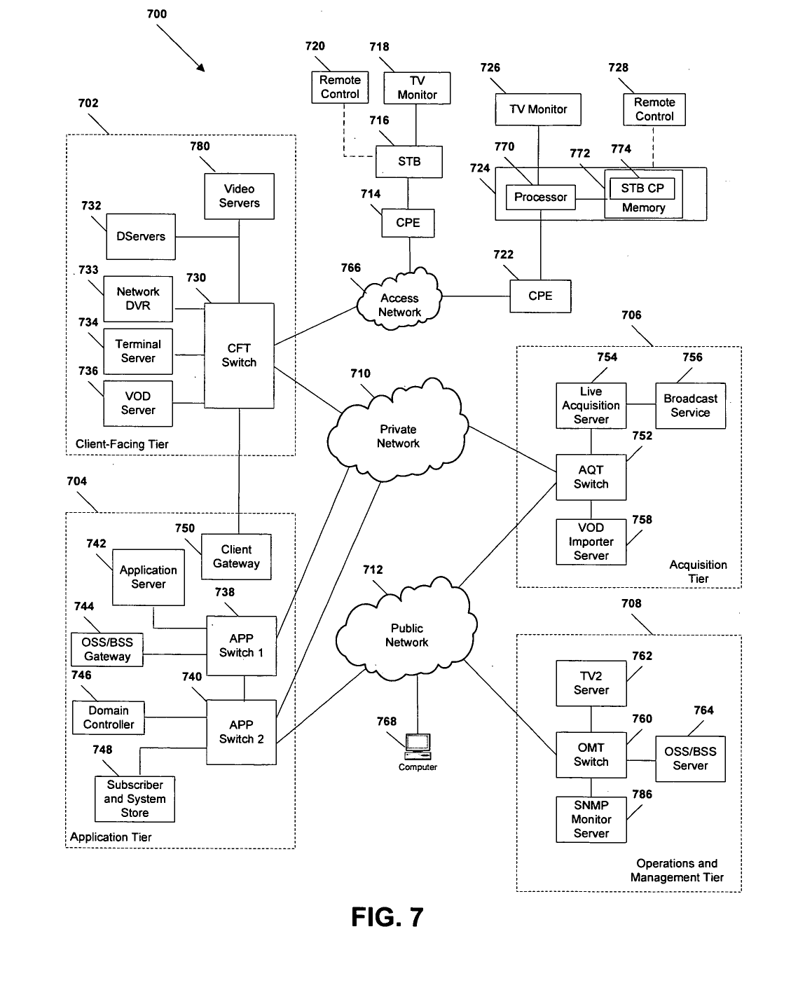

Referring to FIG. 7, an illustrative embodiment of an Internet Protocol Television (IPTV) system that may store and distribute video data is illustrated and is generally designated 700. As shown, the system 700 can include a client facing tier 702, an application tier 704, an acquisition tier 706, and an operations and management tier 708. Each tier 702, 704, 706, 708 is coupled to a private network 710; to a public network 712, such as the Internet; or to both the private network 710 and the public network 712. For example, the client-facing tier 702 can be coupled to the private network 710. Further, the application tier 704 can be coupled to the private network 710 and to the public network 712. The acquisition tier 706 can also be coupled to the private network 710 and to the public network 712. Additionally, the operations and management tier 708 can be coupled to the public network 712.

As illustrated in FIG. 7, the various tiers 702, 704, 706, 707 communicate with each other via the private network 710 and the public network 712. For instance, the client-facing tier 702 can communicate with the application tier 704 and the acquisition tier 706 via the private network 710. The application tier 704 can communicate with the acquisition tier 706 via the private network 710. Further, the application tier 704 can communicate with the acquisition tier 706 and the operations and management tier 708 via the public network 712. Moreover, the acquisition tier 706 can communicate with the operations and management tier 708 via the public network 712. In a particular embodiment, elements of the application tier 704, including, but not limited to, a client gateway 750, can communicate directly with the client-facing tier 702.

The client-facing tier 702 can communicate with user equipment via an access network 766, such as an Internet Protocol Television (IPTV) access network. In an illustrative embodiment, customer premises equipment (CPE) 714, 722 can be coupled to a local switch, router, or other device of the access network 766. The client-facing tier 702 can communicate with a first representative set-top box device 716 via the first CPE 714 and with a second representative set-top box device 724 via the second CPE 722. In a particular embodiment, the first representative set-top box device 716 and the first CPE 714 can be located at a first customer premise, and the second representative set-top box device 724 and the second CPE 722 can be located at a second customer premise. In another particular embodiment, the first representative set-top box device 716 and the second representative set-top box device 724 can be located at a single customer premise, both coupled to one of the CPE 714, 722. The CPE 714, 722 can include routers, local area network devices, modems, such as digital subscriber line (DSL) modems, any other suitable devices for facilitating communication between a set-top box device and the access network 766, or any combination thereof.

In an exemplary embodiment, the client-facing tier 702 can be coupled to the CPE 714, 722 via fiber optic cables. In another exemplary embodiment, the CPE 714, 722 can be digital subscriber line (DSL) modems that are coupled to one or more network nodes via twisted pairs, and the client-facing tier 702 can be coupled to the network nodes via fiber-optic cables. Each set-top box device 716, 724 can process data received via the access network 766, via an IPTV software platform, such as Microsoft® TV IPTV Edition.

The first set-top box device 716 can be coupled to a first external display device, such as a first television monitor 718, and the second set-top box device 724 can be coupled to a second external display device, such as a second television monitor 726. Moreover, the first set-top box device 716 can communicate with a first remote control 720, and the second set-top box device 724 can communicate with a second remote control 728. The set-top box devices 716, 724 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof. Additionally, each set-top box device 716, 724 may be coupled to more than one external display device. Additionally, each set-top box device may communicate with more than one remote control device.

In an exemplary, non-limiting embodiment, each set-top box device 716, 724 can receive data, video, or any combination thereof, from the client-facing tier 702 via the access network 766 and render or display the data, video, or any combination thereof, at the display device 718, 726 to which it is coupled. Each set-top box 716, 724 may also send commands or other information to other devices of the IPTV system via the access network 766. In an illustrative embodiment, the set-top box devices 716, 724 can include tuners that receive and decode television programming signals or packet streams for transmission to the display devices 718, 726. Further, the set-top box devices 716, 724 can include a STB processor 770 and a STB memory device 772 that is accessible to the STB processor 770. In one embodiment, a computer program, such as the STB computer program 774, can be embedded within the STB memory device 772.

In an illustrative embodiment, the client-facing tier 702 can include a client-facing tier (CFT) switch 730 that manages communication between the client-facing tier 702 and the access network 766 and between the client-facing tier 702 and the private network 710. As illustrated, the CFT switch 730 is coupled to one or more data servers, such as D-servers 732, that store, format, encode, replicate, or otherwise manipulate or prepare video content for communication from the client-facing tier 702 to the set-top box devices 716, 724. The CFT switch 730 can also be coupled to a terminal server 734 that provides terminal devices with a connection point to the private network 710. In a particular embodiment, the CFT switch 730 can be coupled to a video-on-demand (VOD) server 736 that stores or provides VOD content imported by the IPTV system 700. Further, the CFT switch 730 is coupled to one or more video servers 780 that receive video content and transmit the content to the set-top boxes 716, 724 via the access network 766. In a particular embodiment, the CFT switch 730 may be coupled to a network DVR server 733, such as the network DVR server depicted in FIGS. 1 and 2.

In an illustrative embodiment, the client-facing tier 702 can communicate with a large number of set-top boxes, such as the representative set-top boxes 716, 724 over a wide geographic area, such as a metropolitan area, a viewing area, a statewide area, a regional area, a nationwide area or any other suitable geographic area, market area, or subscriber or customer group that can be supported by networking the client-facing tier 702 to numerous set-top box devices. In a particular embodiment, the CFT switch 730, or any portion thereof, can include a multicast router or switch that communicates with multiple set-top box devices via a multicast-enabled network.

As illustrated in FIG. 7, the application tier 704 can communicate with both the private network 710 and the public network 712. The application tier 704 can include a first application tier (APP) switch 738 and a second APP switch 740. In a particular embodiment, the first APP switch 738 can be coupled to the second APP switch 740. The first APP switch 738 can be coupled to an application server 742 and to an OSS/BSS gateway 744. In a particular embodiment, the application server 742 can provide applications to the set-top box devices 716, 724 via the access network 766, which enable the set-top box devices 716, 724 to provide functions, such as interactive program guides, video gaming, display, messaging, processing of VOD material and other IPTV content, etc. In an illustrative embodiment, the application server 742 can provide location information to the set-top box devices 716, 724. In a particular embodiment, the OSS/BSS gateway 744 includes operation systems and support (OSS) data, as well as billing systems and support (BSS) data. In one embodiment, the OSS/BSS gateway 744 can provide or restrict access to an OSS/BSS server 764 that stores operations and billing systems data.

The second APP switch 740 can be coupled to a domain controller 746 that provides Internet access, for example, to users at their computers 768 via the public network 712. For example, the domain controller 746 can provide remote Internet access to IPTV account information, e-mail, personalized Internet services, or other online services via the public network 712. In addition, the second APP switch 740 can be coupled to a subscriber and system store 748 that includes account information, such as account information that is associated with users who access the IPTV system 700 via the private network 710 or the public network 712. In an illustrative embodiment, the subscriber and system store 748 can store subscriber or customer data and create subscriber or customer profiles that are associated with IP addresses, stock-keeping unit (SKU) numbers, other identifiers, or any combination thereof, of corresponding set-top box devices 716, 724. In another illustrative embodiment, the subscriber and system store 748 can store data associated with capabilities of set-top box devices 716, 724 associated with particular customers.

In a particular embodiment, the application tier 704 can include a client gateway 750 that communicates data directly to the client-facing tier 702. In this embodiment, the client gateway 750 can be coupled directly to the CFT switch 730. The client gateway 750 can provide user access to the private network 710 and the tiers coupled thereto. In an illustrative embodiment, the set-top box devices 716, 724 can access the IPTV system 700 via the access network 766, using information received from the client gateway 750. User devices can access the client gateway 750 via the access network 766, and the client gateway 750 can allow such devices to access the private network 710 once the devices are authenticated or verified. Similarly, the client gateway 750 can prevent unauthorized devices, such as hacker computers or stolen set-top box devices from accessing the private network 710, by denying access to these devices beyond the access network 766.

For example, when the first representative set-top box device 716 accesses the client-facing tier 702 via the access network 766, the client gateway 750 can verify subscriber information by communicating with the subscriber and system store 748 via the private network 710. Further, the client gateway 750 can verify billing information and status by communicating with the OSS/BSS gateway 744 via the private network 710. In one embodiment, the OSS/BSS gateway 744 can transmit a query via the public network 712 to the OSS/BSS server 764. After the client gateway 750 confirms subscriber and/or billing information, the client gateway 750 can allow the set-top box device 716 to access IPTV content and VOD content at the client-facing tier 702. If the client gateway 750 cannot verify subscriber information for the set-top box device 716, e.g., because it is connected to an unauthorized twisted pair, the client gateway 750 can block transmissions to and from the set-top box device 716 beyond the access network 766.

As indicated in FIG. 7, the acquisition tier 706 includes an acquisition tier (AQT) switch 752 that communicates with the private network 710. The AQT switch 752 can also communicate with the operations and management tier 708 via the public network 712. In a particular embodiment, the AQT switch 752 can be coupled to a live acquisition server 754 that receives or acquires television content, movie content, advertisement content, other video content, or any combination thereof, from a broadcast service 756, such as a satellite acquisition system or satellite head-end office. In a particular embodiment, the live acquisition server 754 can transmit content to the AQT switch 752, and the AQT switch 752 can transmit the content to the CFT switch 730 via the private network 710.

In an illustrative embodiment, content can be transmitted to the D-servers 732, where it can be encoded, formatted, stored, replicated, or otherwise manipulated and prepared for communication from the video server(s) 780 to the set-top box devices 716, 724. The CFT switch 730 can receive content from the video server(s) 780 and communicate the content to the CPE 714, 722 via the access network 766. The set-top box devices 716, 724 can receive the content via the CPE 714, 722, and can transmit the content to the television monitors 718, 726. In an illustrative embodiment, video or audio portions of the content can be streamed to the set-top box devices 716, 724.

In an illustrative embodiment, content can be transmitted to the network DVR 733, where it can be encoded, formatted, stored, replicated, or otherwise manipulated and prepared for retention in a program database.

Further, the AQT switch 752 can be coupled to a video-on-demand importer server 758 that receives and stores television or movie content received at the acquisition tier 706 and communicates the stored content to the VOD server 736 at the client-facing tier 702 via the private network 710. Additionally, at the acquisition tier 706, the video-on-demand (VOD) importer server 758 can receive content from one or more VOD sources outside the IPTV system 700, such as movie studios and programmers of non-live content. The VOD importer server 758 can transmit the VOD content to the AQT switch 752, and the AQT switch 752, in turn, can communicate the material to the CFT switch 730 via the private network 710. The VOD content can be stored at one or more servers, such as the VOD server 736.

When users issue requests for VOD content via the set-top box devices 716, 724, the requests can be transmitted over the access network 766 to the VOD server 736, via the CFT switch 730. Upon receiving such requests, the VOD server 736 can retrieve the requested VOD content and transmit the content to the set-top box devices 716,724 across the access network 766, via the CFT switch 730. The set-top box devices 716, 724 can transmit the VOD content to the television monitors 718, 726. In an illustrative embodiment, video or audio portions of VOD content can be streamed to the set-top box devices 716, 724.

FIG. 7 further illustrates that the operations and management tier 708 can include an operations and management tier (OMT) switch 760 that conducts communication between the operations and management tier 708 and the public network 712. In the embodiment illustrated by FIG. 7, the OMT switch 760 is coupled to a TV2 server 762. Additionally, the OMT switch 760 can be coupled to an OSS/BSS server 764 and to a simple network management protocol (SNMP) monitor server 786 that monitors network devices within or coupled to the IPTV system 700. In a particular embodiment, the OMT switch 760 can communicate with the AQT switch 752 via the public network 712.

In an illustrative embodiment, the live acquisition server 754 can transmit content to the AQT switch 752, and the AQT switch 752, in turn, can transmit the content to the OMT switch 760 via the public network 712. In this embodiment, the OMT switch 760 can transmit the content to the TV2 server 762 for display to users accessing the user interface at the TV2 server 762. For example, a user can access the TV2 server 762 using a personal computer 768 coupled to the public network 712.

In an illustrative embodiment, a user may communicate a reservation request via the first representative STB device 716 using the remote control 720. The first representative STB device 716 may communicate the reservation request to the network DVR 733 via the CPE 714, the access network 766, and the CFT switch 730. The network DVR 733 may create a reservation record associating the user with the recorded program.

In an illustrative embodiment, when the user desires to watch a recorded program, the user may send a request to identify programs the user has reserved via the first representative STB device 716 using the remote control 720. The network DVR 733 may query the reservation records associated with the user and send data identifying the programs the user has reserved to the first representative STB device 716. The first representative STB device 716 may generate a user interface listing the programs that the user has reserved and display the user interface at TV monitor 718. The user may select a program to play from the user interface using the remote control 720. In response, the first representative STB device 716 may send a request to playback the program. The network DVR 733 may access the program in memory, and transmit the program data to the first representative STB device 716 in an appropriate format. The first representative STB device 716 may receive the program data and generate a display at the TV monitor 726 including the program.

In an illustrative embodiment, the user may send a request to display data related to the user's account via the first representative STB device 716 using the remote control 720. The data related to the user's account may include administrative information, user settings, user limits, other user account information or any combination thereof. For example, the data related to the user's account may include an amount of the user reservation limit used and/or an amount of the user reservation limit available. The network DVR 733 may query records associated with the user's account and send data related to the user's account to the first representative STB device 716. The first representative STB device 716 may generate a user interface listing the data related to the user's account and display the user interface at TV monitor 718.

In an illustrative embodiment, the user may administer the user's account via the first representative STB device 716 using the remote control 720. For example, after data related to the user's account is displayed, the user may request changes to the user's account. For example, the user may request deletion of a reservation. The network DVR 733 may modify records associated with the user's account and send data related to the user's account to the first representative STB device 716. The first representative STB device 716 may generate a user interface listing the modified data related to the user's account and display the user interface at TV monitor 718.

In a particular illustrative embodiment, the network DVR 733 or the first representative STB device 716 may include an alternate advertisement in the program during playback. To add alternate advertisements or to inhibit avoiding advertisements, the network DVR 733, the live acquisition server 754, or the broadcast service 756 may place advertisement markers in a program data file used to store the program in memory. Each advertisement marker may indicate the beginning of an advertisement or block of advertisements, or the end of an advertisement or block of advertisement. For example, the network DVR 733 may insert the advertisement markers based on information derived from the program itself, information received from a television content provider, or any combination thereof.

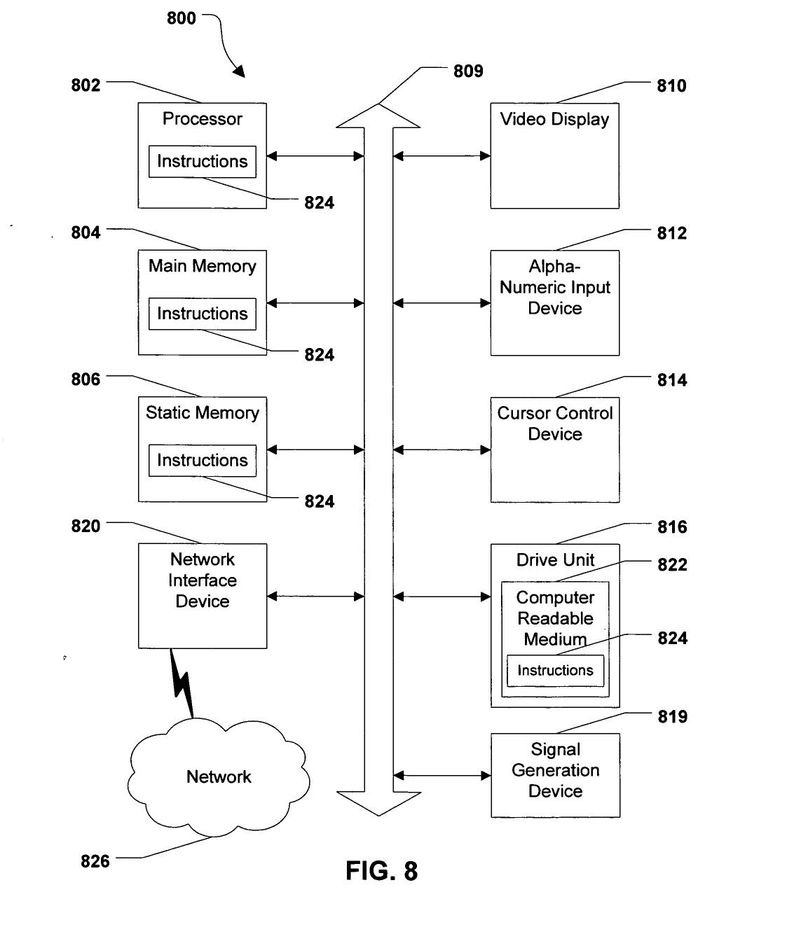

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800, or any portion thereof, may operate as a standalone device or may be connected, e.g., using a network, to other computer systems or peripheral devices, including a network DVR server, other server or set-top box device, as shown in FIGS. 1, 2, and 7.

In a networked deployment, the computer system 800 may operate in the capacity of an IPTV server, such as a video server, an application server, a network DVR server, or a set-top box device. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics-processing unit (GPU), or both. Moreover, the computer system 800 can include a main memory 804 and a static memory 806 that can communicate with each other via a bus 809. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 876, a signal generation device 819, such as a speaker or remote control, and a network interface device 820. In a particular embodiment, the bus 809 may include a network interface connecting one or more components of the computer system. For example, the drive unit 816, the alpha-numeric input device 812, the video display 810 or one or more of the other computer system components may communicate via the network interface.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 38 C.F.R. §9.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of storing video data comprising:
receiving a reservation request to reserve a program for a user;
determining whether a reservation window associated with the program has expired, wherein the reservation window is based at least partially on a previously received reservation request; and
storing a reservation record associating the program with the user after determining that the reservation window has not expired.

2. The method of claim 1, wherein the reservation window is based at least partially on a predetermined maximum time limit.

3. The method of claim 1, wherein the reservation window is based at least partially on a rate at which a plurality of reservation requests associated with the program were received.

4. The method of claim 1, wherein the reservation window is based at least partially on a type of the program.

5. The method of claim 1, wherein the reservation window is based at least partially on popularity of the program.

6. The method of claim 1, further comprising determining whether a reservation limit associated with the user has been met before storing the reservation record.

7. The method of claim 6, wherein the reservation limit includes number of reservation hours.

8. The method of claim 1, further comprising modifying the reservation record so that the program is no longer associated with the user after determining that a reservation time limit has expired.

9. A system for storing and accessing video data comprising:
a memory to store a plurality of program data files associated with recorded programs; and
a retention module to determine whether to retain each of the plurality of program data files based at least partially on a variable retention window, wherein the variable retention window is varied based at least partially on user interaction with the recorded programs.

10. The system of claim 9, further comprising a reservation module to generate reservation records, wherein each reservation record associates at least one user with at least one recorded program.

11. The system of claim 10, wherein at least one reservation record includes a time limit and wherein the retention module determines whether to retain at least one program data file based on the time limit.

12. The system of claim 10, wherein the retention module deletes at least one program data file after determining that fewer than a threshold number of reservation records are associated with the at least one program data file.

13. The system of claim 10, further comprising a user interface module to generate a user interface indicating one or more recorded programs associated with the at least one user based on the reservation records.

14. The system of claim 10, further comprising a user interface module to generate a user interface indicating one or more programs available to be reserved by the at least one user based on data from the reservation module.

15. The system of claim 10, wherein the reservation module determines whether a program is available to be reserved by a user based on a variable reservation window.

16. The system of claim 9, further comprising a playback module to transmit at least one of the recorded programs to a remote user device.

17. The system of claim 16, wherein the retention module deletes at least one recorded program after determining that more than a threshold amount of time has passed since a playback request for the at least one recorded program was requested.

18. The system of claim 16, wherein the at least one recorded program is transmitted to the remote user device via an internet protocol television (IPTV) system.

19. The system of claim 16, wherein the playback module further selects and transmits at least one alternate advertisement with the at least one recorded program.

20. The system of claim 9, wherein the system includes a network digital video recorder system.

21. A method of storing video data comprising:
determining whether a variable retention window associated with a program has expired; and
deleting the program after determining that the variable retention window has expired.

22. The method of claim 21, wherein the variable retention window is extended in response to receiving a new playback request associated with the program.

23. The method of claim 21, wherein the variable retention window is extended in response to receiving a new reservation request associated with the program.

24. The method of claim 21, wherein the variable retention window is shortened in response to the reservation window associated with the program being shortened.

25. The method of claim 21, wherein the variable retention window is extended in response to the reservation window associated with the program being extended.

26. The method of claim 21, further comprising determining whether a fixed retention window associated with the program has expired, and deleting the program after determining that the fixed retention window has expired.

27. The method of claim 26, wherein the fixed retention window is based at least partially on a type of the program.
